(19) United States
(12) Patent Application Publication
(10) Pub. No.: US 2013/0298041 A1
(43) Pub. Date: Nov. 7, 2013

(54) Portable Collaborative Interactions

(71) Applicant: Richard Lang, Sebastopol, CA (US)

(72) Inventor: Richard Lang, Sebastopol, CA (US)

(21) Appl. No.: 13/859,624

(22) Filed: Apr. 9, 2013

Related U.S. Application Data
(60) Provisional application No. 61/621,965, filed on Apr. 9, 2012.

(51) Int. Cl. H04L 29/06

(52) U.S. Cl. CPC H04L 65/403
USPC 715/753

(57) ABSTRACT

The present system allows for online collaborative interaction(s) of various engagement types, without the need for all collaborators to necessarily be registered to or using an identical collaboration application. An interface for engaging in a collaborative environment may allow for identical functionality or a reduced set of functionality that ensures the ability to engage in fundamental online collaborative activities related to the environment. The shared collaborative environment may be accessed from a variety of different computing devices, including various mobile devices. The entire shared collaborative environment may also be embedded an a variety of other platforms and applications that benefit from the added functionality and benefits that the invention provides.

### CROSS-REFERENCE TO RELATED APPLICATIONS

The present application claims the priority benefit of U.S. provisional application No. 61/621,965 filed Apr. 9, 2012, the disclosure of which is incorporated herein by reference.

### BACKGROUND OF THE INVENTION

1. Field of the Invention

The present invention generally related to collaborative interactions amongst users. More specifically, the present invention concerns allowing for online collaborative interactions without regard for any given working environment or platform.

2. Description of the Related Art

Numerous online collaborative work environment applications exist in the marketplace. These applications allow for users to work with one another and exchange ideas as if in one space, notwithstanding any particular distance between those users. Examples include web conferencing, chat applications, collaborative work space applications like Sharepoint, and other cloud-based storage solutions like Dropbox. In order to engage in such a collaborative environment, however, requires the use of a common application and destination site amongst all users which all users have subscribed to in some fashion.

For example, in order to engage in a web conference, all the users must be registered to and using a common web conferencing application such as WebEx. In order for all users to work on a common document, they must be all be registered to and using Sharepoint. For all users to access common documents in a cloud storage, they must all be registered to and using Dropbox. While the ease of use for these applications has increased in light of the migration to cloud-based SaaS (Software As A Service) type solutions, there are still licensing or access fees, as well as registration requirements which can be prohibitive in many instances. If any one user from amongst a group of users is without access to the particular application (SaaS or otherwise), then the ability of all the users to interact suffers.

There is a need in the art for an online collaboration solution that does not require all collaborative users to have registered to and have identical access to the same end-user application(s).

### BRIEF DESCRIPTION OF THE DRAWINGS

FIG. 1 illustrates an exemplary collaboration template.

FIG. 2 illustrates the fulfillment of a template to allow for collaborative engagement.

FIG. 3 illustrates posting a discussion to a native collaboration environment.

FIG. 4 illustrates a native environment for collaborative engagement.

FIG. 5 illustrates the activation of a sharing feature to allow for discussion outside of a native collaborative environment.

FIG. 6 illustrates collaboration and interaction with input that might come from a native and non-native collaboration environment.

### SUMMARY OF THE INVENTION

Embodiments of the present invention allow for online collaborative interaction(s) of various engagement types, without the need for all collaborators to necessarily be registered to or using an identical collaboration application.

In some instances, an alternative interface for engaging in a collaborative environment may allow for identical functionality or a reduced set of functionality that nevertheless ensures the ability to engage in fundamental online collaborative activities related to the environment.

In some instances, the shared collaborative environment may be accessed from a variety of different computing devices, including various mobile devices.

In other cases, the entire shared collaborative environment may be embedded an a variety of other platforms and applications that benefit from the added functionality and benefits that the invention provides.

### DETAILED DESCRIPTION

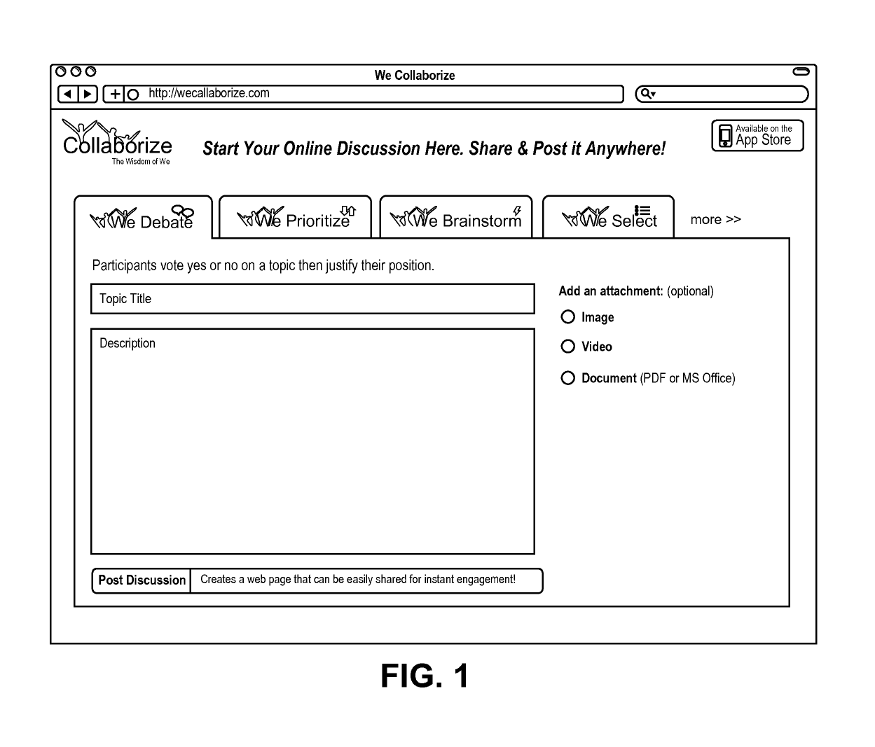

FIG. 1 illustrates an exemplary online collaboration template. Through this template, a user or group of users might collaborate on any number of issues. The methods of collaboration can vary, from prioritizing or ranking goals, objectives, favorites a category, etc., to brainstorm solutions to an issue, by collecting ideas from all participants and then providing for the ranking of those ideas or solutions, to selecting a particular idea from a list, designated for further action. These are only examples. Any of a vast number of engagement types for group collaboration may be provided. This online collaboration template allows for various users who may not be physically present to engage in a collaborative and/or real-time discussion that includes specific objective outcomes or solutions (in addition to the subjective data that comes from a more-limited discussion-only collaboration), and that helps aid in generating dynamic solutions to pertinent issues and problems of the day, as well as ongoing group decision-making.

It should be noted that the template of FIG. 1 is exemplary. In some embodiments, only a collaborative discussion will take place without further more structured activities such as prioritization, brainstorming, selection, etc. In other embodiments, for instance, a debate may lead directly to brainstorming without prioritization. The introduction and inclusion of images, documents, and/or videos into a particular structured collaborative discussion may occur in some instances. In all instances, however, the engagement and collaborative interaction allows for dissemination of the individual collaboration topic to individual third-parties that might not yet be a part of the collaboration or, alternatively, to introduce users who may not necessarily have access to a common application allowing for collaborative discussion in a native environment. The means for implementing that collaborative discussion amongst third-parties and/or those not already a part of the native environment is reflected by way of the “Post Discussion” function at the bottom of the interface (the word “Discussion” in these examples refers to a collaborative discussion that includes objective structured engagement elements for decision-making and other collaborative activities).

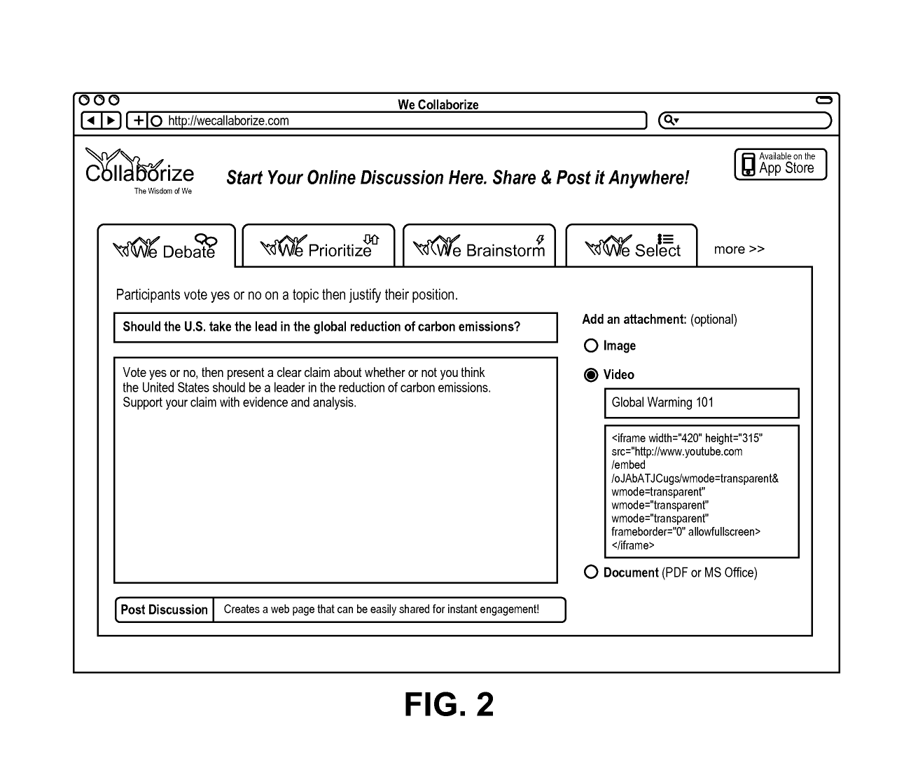

FIG. 2 illustrates the fulfillment of a template to allow for collaborative engagement. A user has provided a particular topic for collaborative discussion (reducing carbon emissions) and offered a query with respect to whether the U.S. should take the lead on the same. The user has also introduced a video by way of either an HTML link to the video content, or, as in FIG. 2, the “embed code,” which serves to provide same. This collaborative topic is now self-contained, portable and accessible on a dedicated web location, whose web location is represented by a specific URL address that is disseminated by the originator of the portable topic, via email or any other number of dissemination mechanisms.

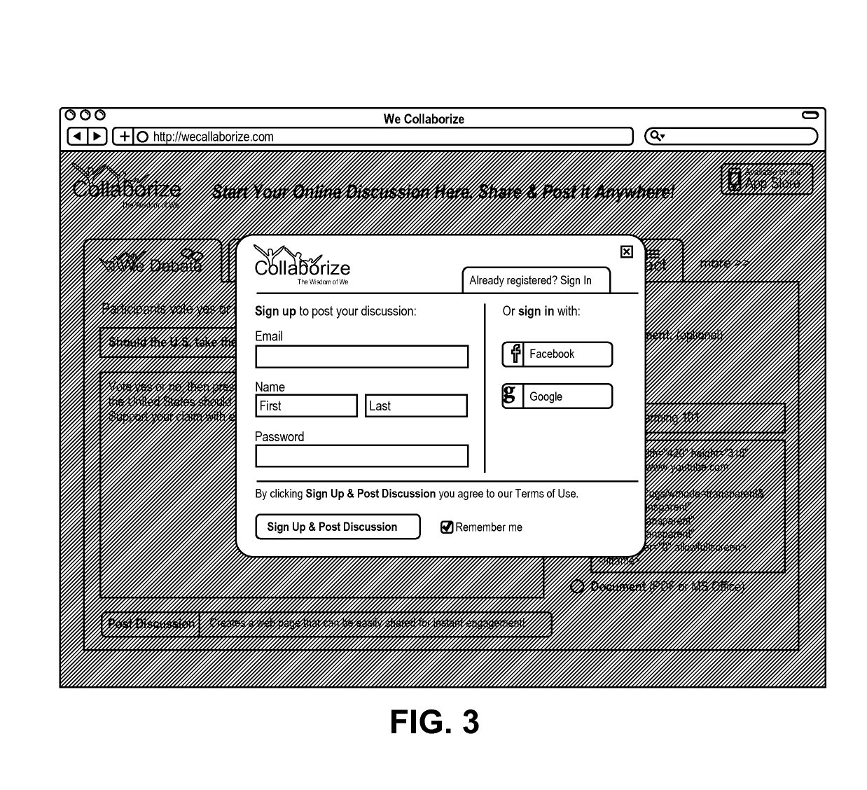

FIG. 3 illustrates posting a collaborative discussion within a native collaboration environment. As shown in FIG. 3, a user may initially provide an email address, name, and password to sign up for functionality related to not only posting in a native environment but also for enabling the portability of an individual collaborative discussion to a non-native environment. A user may also sign-in if already a registered user, in addition to signing in with a third-party user name/password solution as might be offered by a social network or other online service such as Facebook, Twitter or Google. Not only do social networks and services like these examples typically have a large user base with a user name/password combination, which may speed the process of signing-in subsequent to an original registration, but combining the present collaborative discussion capability with any one of those networks allows for an individual collaborative discussion to reach as many people as possible (typically more than might be reached via an emailing alone), and a number of which might be particularly interested in the collaboration discussion topic, due to their social relationship with a user making the post (sharing the discussion).

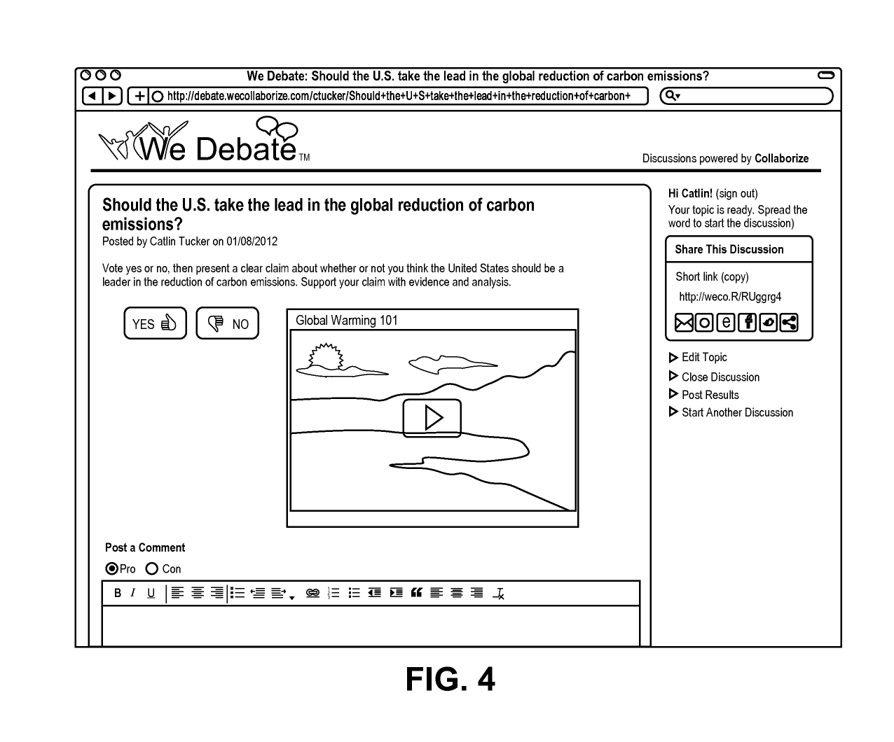

FIG. 4 illustrates a native environment for collaborative engagement. The native environment of FIG. 4 corresponds to the topic, query, and content generated in the context of FIG. 2. This native environment is, in FIG. 4, a dedicated webpage (or a website consisting of one page), which is associated with a specific URL address. Having received the link or other direct connection to this specific URL address, a new user/participant in the collaborative discussion can then participate in whatever type of objective engagement is provided by the originator of the collaborative discussion (for instance, voting “yes” or “no” on a particular question) and also post a comment using the selection feature and discussion or comment box at the bottom of the interface. The collaborative discussion can also be further spread to a non-native environment by using the sharing feature on the right hand side of the screen, which creates a (or copies the original) link to the discussion that can be cut and pasted into a browser or email as well as further shared over a social network such as Google +, Facebook, and Twitter. By porting the collaborative discussion (or the means to access the discussion) through a social network, the opportunity for engagement, discussion, and collaboration is increased by virtue of the larger number of participants that are accessed through this process.

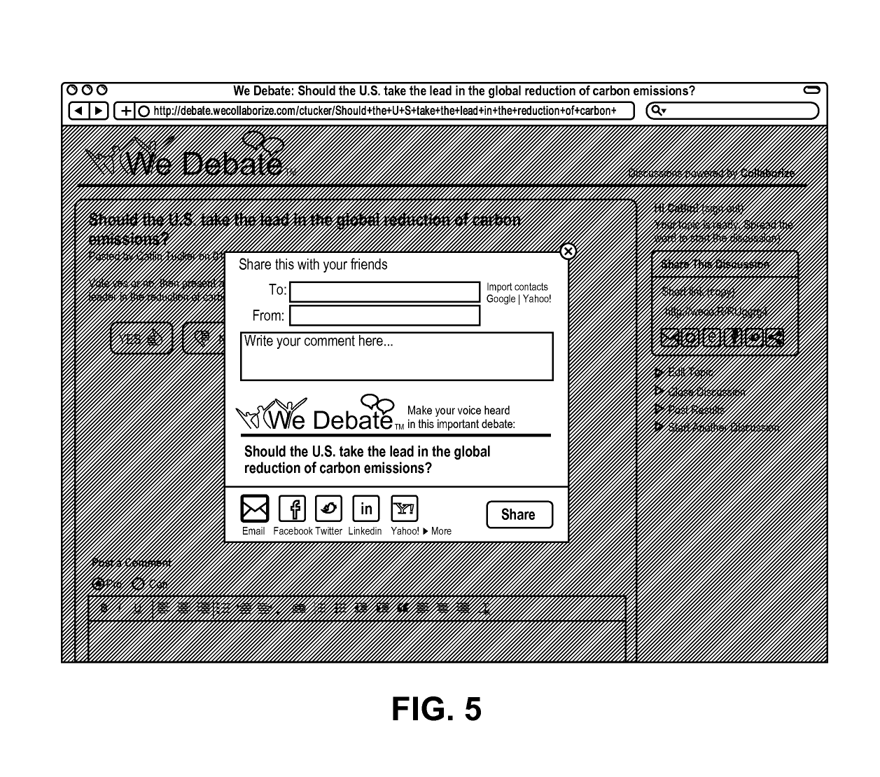

FIG. 5 illustrates the activation of a sharing feature to allow for discussion outside of a native collaborative environment. As shown in FIG. 5, a user may identify specific users with whom to share the discussion by way of an email address. Importing of contacts may also be implemented from a pre-existing contacts database. A comment may also be provided by a user inviting a third-party to the discussion such that the recipient understands the context of the discussion to which the user is being invited.

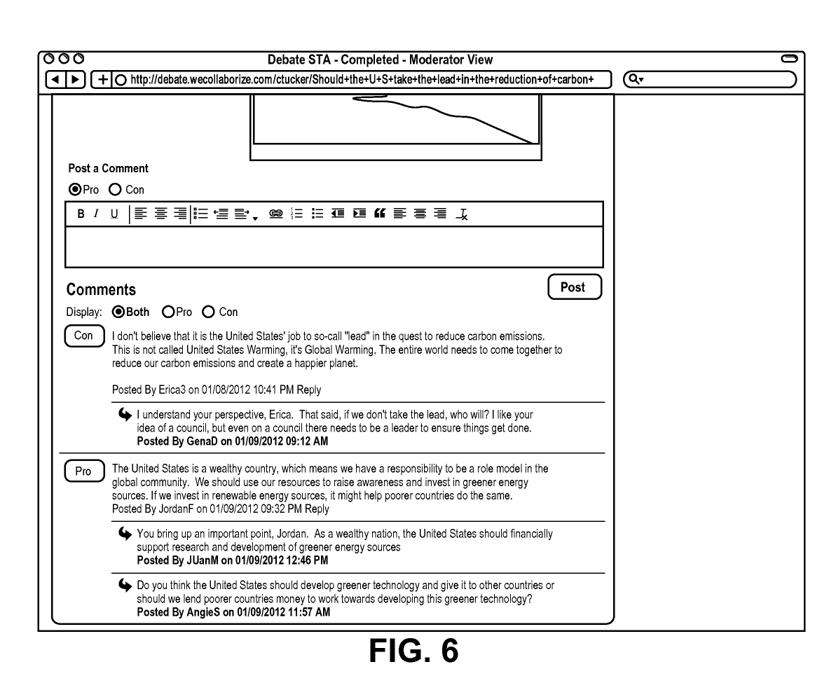

By using the sharing feature of FIG. 5, a third-party may be taken into a basic or non-subscriber level of the collaborative environment (e.g., a shareware type level or introductory/try-out level) or may be taken to a wholly different environment that lacks certain features of the native environment, but still allows for collaboration and interaction as shown in FIG. 6. The comments shown in the discussion portion may be generated in the native environment but may also come from a third-party non-native environment such as a hosted webpage.

In some embodiments, through the use of sharing, content generated in either environment may also be published to a social network or via email or other means of communication to provide updates on the discussion and to further encourage interaction.

The foregoing examples are illustrative and not intended to be limiting.

What is claimed is:

1. A system for online collaboration, the system comprising:
a first online collaborative environment for commencing a discussion, wherein the first collaborative environment allows for:
a collaborative discussion to be initiated,
the discussion to be structured with a selected engagement or collaboration type,
the discussion to take place, and
the dissemination of said discussion to third-parties in one or more locations (web-based and otherwise), via any number of distribution mechanisms.

2. The system of claim 1, wherein the third-parties also take place in the first collaborative environment.

3. The system of claim 1, wherein the third-parties participate in a second collaborative environment.

4. The system of claim 3, wherein a user of the first collaborative environment and a user of the second collaborative environment each see the discussions, comments and interactions (i.e. votes) of one another in their respective environments.

5. The system of claim 4, wherein any participant, regardless of physical location, sees and participates in the identical individual collaborative discussion, which includes the input, votes, and commentary of all participants.

6. The system of claim 4, wherein the second collaborative environment is a simplified operating version of the first environment.

7. The system of claim 4, wherein the second collaborative environment is hosted by a web server.

8. The system of claim 1, wherein the introduction of third-parties takes place through a social network.

9. The system of claim 7, wherein the social network also allows for publishing of the discussion in a variety of locations.
